(19) United States
(12) Patent Application Publication
(10) Pub. No.: US 2024/0159791 A1
(43) Pub. Date: May 16, 2024

(54) ACCELERATION DETECTION DEVICE AND MOUNTING ANGLE DETECTION METHOD

(71) Applicant: DENSO CORPORATION, Kariya-city (JP)

(72) Inventors: Chao CHEN, Kariya-city (JP); Naoki YOSHIDA, Kariya-city (JP)

(21) Appl. No.: 18/416,769

(22) Filed: Jan. 18, 2024

Related U.S. Application Data
(63) Continuation of application No. PCT/JP2022/025336, filed on Jun. 24, 2022.

(30) Foreign Application Priority Data
Jul. 22, 2021 (JP) 2021-121107

(51) Int. Cl. G01P 15/18; G01P 21/00

(52) U.S. Cl. CPC G01P 15/18; G01P 21/00

(57) ABSTRACT

An acceleration detection device includes an acceleration sensor that has a first detection axis and a second detection axis such that a yaw mounting angle between a vehicle reference axis and a virtual line is ±15 degrees or less, an acquisition section acquiring an acceleration in a direction of the first detection axis and an acceleration in a direction of the second detection axis, and a mounting angle calculation section calculating the yaw mounting angle from an angle calculation formula and the acceleration in the direction of the first detection axis and the acceleration in the direction of the second detection axis.

### CROSS REFERENCE TO RELATED APPLICATIONS

The present application is a continuation application of International Patent Application No. PCT/JP2022/025336 filed on Jun. 24, 2022 which designated the U.S. and claims the benefit of priority from Japanese Patent Application No. 2021-121107 filed on Jul. 22, 2021. The entire disclosures of all of the above applications are incorporated herein by reference.

### TECHNICAL FIELD

The present disclosure relates to an acceleration detection device and a mounting angle detection method for detecting a mounting angle of an acceleration sensor.

### BACKGROUND

A related art discloses a technique of calculating an angle (hereinafter, yaw mounting angle θy) between a vehicle front-rear direction axis and a sensor x-axis, based on θy=sin⁻¹ (−A_{SY}/A_{BX}). In the above equation, A_{SY} is an acceleration in a sensor y-axis direction detected by an acceleration sensor, and A_{BX} is an acceleration in a vehicle front direction. The acceleration A_{BX} in the vehicle front-rear direction is calculated from a change in speed in the vehicle front-rear direction detected by a speed sensor when the vehicle is traveling straight on a horizontal plane.

### SUMMARY

One example of the present disclosure, an acceleration detection device includes an acceleration sensor that has a first detection axis and a second detection axis such that a yaw mounting angle between a vehicle reference axis and a virtual line is ±15 degrees or less, an acquisition section acquiring an acceleration in a direction of the first detection axis and an acceleration in a direction of the second detection axis, and a mounting angle calculation section calculating the yaw mounting angle from an angle calculation formula and the acceleration in the direction of the first detection axis and the acceleration in the direction of the second detection axis.

### BRIEF DESCRIPTION OF DRAWINGS

FIG. 1 is a diagram illustrating directions of an sx-axis and an sy-axis included in an acceleration sensor.

FIG. 2 is a diagram illustrating a direction of an sz-axis included in the acceleration sensor.

FIG. 3 is a diagram illustrating a configuration of an acceleration detection device.

FIG. 4 is a diagram illustrating equations in a process of deriving an angle calculation formula used in a first embodiment.

FIG. 5 is a diagram illustrating a flow of processing until a yaw mounting angle Δθ is calculated.

FIG. 6 is a diagram illustrating directions of an acceleration A by Aₛₓ+A_{sy} and Aₛₓ−A_{sy}.

FIG. 7 is a diagram illustrating an approximate straight line that approximates the relationship between Aₛₓ+A_{sy} and Aₛₓ−A_{sy}.

FIG. 8 is a diagram illustrating a configuration of an acceleration detection device of a second embodiment.

FIG. 9 is a diagram illustrating processing performed by an abnormality determination section.

FIG. 10 is a view illustrating a state where a mounting angle detection method in a third embodiment is performed.

FIG. 11 is a diagram illustrating a configuration of an acceleration detection device of a third embodiment.

FIG. 12 is a view illustrating a mounting direction of the acceleration sensor of a fourth embodiment.

FIG. 13 is a diagram illustrating equations in a process of deriving an angle calculation formula used in the fourth embodiment.

FIG. 14 is a view illustrating a mounting direction of the acceleration sensor of a fifth embodiment.

FIG. 15 is a diagram illustrating equations in a process of deriving an angle calculation formula used in the fifth embodiment.

FIG. 16 is a view illustrating a mounting direction of the acceleration sensor of a sixth embodiment.

FIG. 17 is a diagram illustrating equations in a process of deriving an angle calculation formula used in the sixth embodiment.

FIG. 18 is a diagram illustrating equations in a process of deriving an angle calculation formula used in a seventh embodiment.

FIG. 19 is a diagram illustrating equations in a process of deriving an angle calculation formula used in an eighth embodiment.

### DETAILED DESCRIPTION

Because the acceleration sensor is fixed to the casing, the yaw mounting angle θy of the acceleration sensor can also be determined by the technique disclosed in a related art. However, it is necessary to calculate the acceleration A_{BX} in the vehicle front-rear direction from the change in speed in the vehicle front-rear direction detected by the speed sensor when the vehicle is traveling straight on a horizontal plane. Therefore, in a case where the vehicle and the acceleration sensor is inclined with respect to the horizontal plane, for example, in a case where the road surface on which the vehicle is traveling is inclined, the calculation accuracy of the yaw mounting angle θy is lower.

The present disclosure provides an acceleration detection device and a mounting angle detection method capable of preventing or reducing a decrease in calculation accuracy of a mounting angle of an acceleration sensor.

According to one aspect of the present disclosure, an acceleration detection device mounted on a vehicle is provided. The acceleration detection device comprises: an acceleration sensor that has at least a first detection axis and a second detection axis orthogonal to each other and is mounted on the vehicle such that a yaw mounting angle between a vehicle reference axis that is either a vehicle front-rear direction axis or a vehicle width direction axis and a virtual line set between the first detection axis and the second detection axis is ±15 degrees or less; an acquisition section that is configured to acquire, from the acceleration sensor, an acceleration in a direction of the first detection axis and an acceleration in a direction of the second detection axis in a state where acceleration in the vehicle front-rear direction is generated in the vehicle and no acceleration is generated in the vehicle width direction; and a mounting angle calculation section that is configured to calculate the yaw mounting angle from an angle calculation formula that calculates the yaw mounting angle from an acceleration in the direction of the first detection axis and an acceleration in the direction of the second detection axis and the acceleration in the direction of the first detection axis and the acceleration in the direction of the second detection axis detected by the acquisition section, the angle calculation formula being derived by assuming a state where acceleration in the vehicle front-rear direction is generated in the vehicle and no acceleration is generated in the vehicle width direction and by using a fact that a tan value of the yaw mounting angle is approximated to the yaw mounting angle.

When assuming that the acceleration sensor is disposed as described above, that the acceleration in the vehicle front-rear direction is generated, and that substantially no acceleration is generated in the vehicle width direction, and using the fact that the tan value of the yaw mounting angle can be approximated to the yaw mounting angle, it is possible to derive the angle calculation formula for calculating the yaw mounting angle from the acceleration in the first detection axis direction and the acceleration in the second detection axis direction.

Therefore, the mounting angle calculation section calculates the yaw mounting angle from (i) the acceleration in the first detection axis direction and the acceleration in the second detection axis direction acquired by the acquisition section in a state where acceleration in the vehicle front-rear direction is generated in the vehicle and substantially no acceleration is generated in the vehicle width direction and (ii) the above-mentioned angle calculation formula.

The angle calculation formula is a formula derived assuming a state where acceleration is generated in the vehicle front-rear direction and no acceleration is generated in the vehicle width direction. When the vehicle is inclined in the front-rear direction, acceleration caused by the inclination in the front-rear direction of the vehicle is applied along the first detection axis and the second detection axis. However, the angle calculation formula is a formula assuming that acceleration is generated in the vehicle front-rear direction. Therefore, even in a case where the first detection axis and the second detection axis of the acceleration sensor are inclined in the vehicle front-rear direction with respect to the horizontal plane for, for example, a reason that the road surface on which the vehicle is traveling is inclined in the vehicle front-rear direction, a decrease in a calculation accuracy of the yaw mounting angle is prevented or reduced.

According to one aspect of the present disclosure, a mounting angle detection method for detecting a mounting angle of an acceleration sensor that has at least a first detection axis and a second detection axis orthogonal to each other and is disposed on a vehicle such that a yaw mounting angle between a vehicle reference axis that is either a vehicle front-rear direction axis or a vehicle width direction axis and a virtual line set between the first detection axis and the second detection axis is ±15 degrees or less is provided. The method comprises: acquiring, from the acceleration sensor, an acceleration in a direction of the first detection axis and an acceleration in a direction of the second detection axis in a state where acceleration in the vehicle front-rear direction is generated in the vehicle and substantially no acceleration is generated in the vehicle width direction; and calculating the yaw mounting angle from an angle calculation formula that calculates the yaw mounting angle from an acceleration in the direction of the first detection axis and an acceleration in the direction of the second detection axis and the acceleration in the direction of the first detection axis and the acceleration in the direction of the second detection axis acquired, the angle calculation formula being derived by assuming a state where acceleration in the vehicle front-rear direction is generated in the vehicle and no acceleration is generated in the vehicle width direction and by using a fact that a tan value of the yaw mounting angle is approximated to the yaw mounting angle.

### First Embodiment

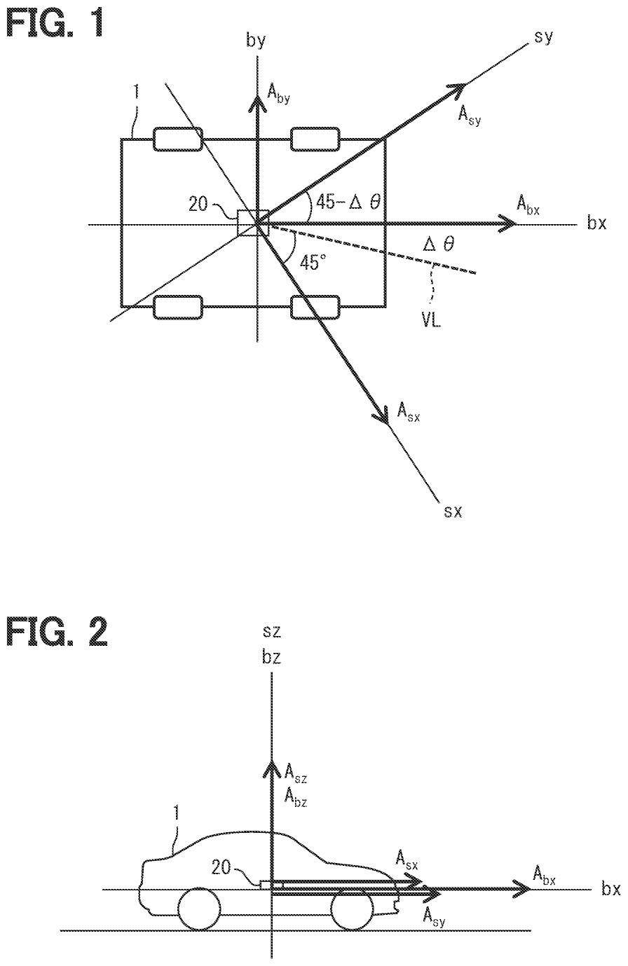

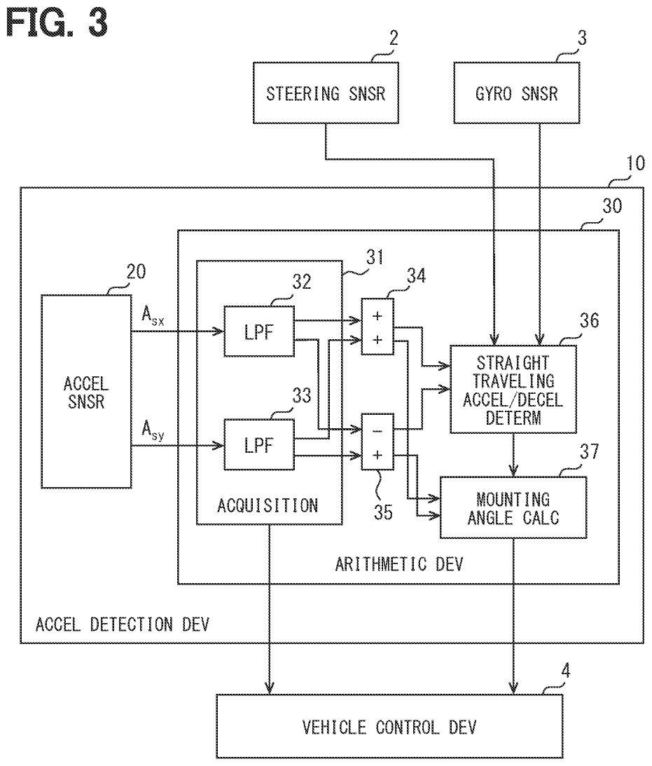

Hereinafter, an embodiment will be described with reference to the drawings. FIG. 1 is a diagram illustrating directions of an sx-axis and an sy-axis of an acceleration sensor 20 included in an acceleration detection device 10 (see FIG. 3) of the present embodiment. The acceleration sensor 20 is mounted on a vehicle 1. A front-rear direction of the vehicle 1 is a bx direction, and a vehicle width direction of the vehicle 1 is a by direction. An axis representing the bx direction may be referred to as a bx-axis, and an axis representing the by direction may be referred to as a by-axis. The bx-axis is a vehicle front-rear direction axis, and the by-axis is a vehicle width direction axis. As illustrated in FIG. 2, the vertical direction of the vehicle 1 is defined as a bz direction. An axis representing the bz direction is sometimes described as a bz-axis.

The sx-axis and the sy-axis included in the acceleration sensor 20 are axes representing directions in which the acceleration sensor 20 detects an acceleration A. The sx-axis that is a first detection axis and the sy-axis that is a second detection axis are in the same plane and orthogonal to each other. The acceleration sensor 20 also includes an sz-axis as illustrated in FIG. 2. The sz-axis is an axis orthogonal to the sx-axis and the sy-axis. The acceleration sensor 20 detects the acceleration A in each of the three axial directions.

As illustrated in FIGS. 1 and 2, the acceleration in each axial direction is denoted by “A” with a subscript indicating the axis. Therefore, the accelerations A_{bx}, A_{by}, and A_{bz} respectively represent the acceleration A in the bx-axis, by-axis, and bz-axis directions. The accelerations Aₛₓ, A_{sy}, and A_{sz} respectively represent an acceleration A in the sx-axis direction (that is, the first detection axis direction), an acceleration A in the sy-axis direction (that is, the second detection axis direction), and an acceleration A in the sz-axis direction.

The sx-axis and the sy-axis are disposed along a vehicle plane including the front-rear direction and the left-right direction of the vehicle 1. The vehicle plane includes the bx-axis and the by-axis. However, it is difficult to mount the acceleration sensor 20 on the vehicle 1, via a casing or the like in which the acceleration sensor 20 is accommodated, such that a plane (hereinafter, a sensor plane) including the sx-axis and the sy-axis of the acceleration sensor 20 is completely parallel to the vehicle plane. When the sensor plane and the vehicle plane are substantially parallel, it can be said that the sensor plane is along the vehicle plane. However, when the sensor plane and the vehicle plane are not parallel, the bz-axis and the sz-axis do not coincide with each other.

Therefore, after the acceleration sensor 20 is mounted on the vehicle 1, misalignment between the bz-axis and the sz-axis is detected, whereby the acceleration A_{sz} is corrected and used to control the vehicle. The misalignment between the bz-axis and the sz-axis can be detected by detecting the deviation between the direction of a gravity vector and the sz-axis.

It is also difficult to mount the acceleration sensor 20 such that the sx-axis and the sy-axis of the acceleration sensor 20 strictly coincide with predetermined directions of the vehicle 1. However, unlike the misalignment between the bz-axis and the sz-axis, it is difficult to detect, by using the gravity vector, the misalignment between the sx-axis and the bx-axis and the misalignment between the sy-axis and the by-axis.

To address this issue, in the acceleration detection device 10 of the present embodiment, a virtual line VL is set between the sx-axis and the sy-axis of the acceleration sensor 20. The virtual line VL of the present embodiment bisects the space between the sx-axis and the sy-axis on the same plane as the plane on which the sx-axis and the sy-axis are on. The acceleration sensor 20 is mounted on the vehicle 1 such that an angle (hereinafter, a yaw mounting angle) Δθ between the virtual line VL and the bx-axis is ±15° or less with the bx-axis as a vehicle reference axis.

Although it is difficult to mount the acceleration sensor 20 on the vehicle 1 such that the yaw mounting angle Δθ is 0°, it is easy to mount the acceleration sensor 20 on the vehicle 1 such that the yaw mounting angle Δθ is ±15° or less. When the acceleration sensor 20 is mounted on the vehicle 1 such that the yaw mounting angle Δθ is ±15° or less, it is easy to calculate the yaw mounting angle Δθ as described below. If the yaw mounting angle Δθ can be calculated, the directions of the sx-axis and the sy-axis can also be calculated.

### Configuration of Acceleration Detection Device 10

FIG. 3 illustrates a configuration of the acceleration detection device 10. The acceleration detection device 10 includes an acceleration sensor 20 and an arithmetic device 30. Of the configuration included in the arithmetic device 30, FIG. 3 mainly illustrates a configuration for calculating the yaw mounting angle Δθ and omits the configuration unrelated to the configuration for calculating the yaw mounting angle Δθ.

The arithmetic device 30 can be implemented by a computer including a processor, a non-volatile memory, a random-access memory (RAM), an input/output (I/O), a bus line connecting these components, and the like. The arithmetic device 30 may include a hardware logic circuit in addition to the processor. The non-volatile memory stores a program for causing a general-purpose computer to operate as the arithmetic device 30. The processor executes the program stored in the non-volatile memory while using a temporary storage function of the RAM, so that the arithmetic device 30 implements the function as each section illustrated in FIG. 3. In addition, in a case where the arithmetic device 30 functions as each unit illustrated in FIG. 3, it means that a method corresponding to the above-mentioned program is performed.

As illustrated in FIG. 3, the arithmetic device 30 functions as an acquisition section 31, an addition section 34, a subtraction section 35, a straight traveling acceleration/deceleration determination section 36, and a mounting angle calculation section 37. The acquisition section 31 acquires signals representing the accelerations Aₛₓ, A_{sy}, and A_{sz} of the three axes from the acceleration sensor 20. The acquisition section 31 sequentially outputs the signals representing the acquired accelerations Aₛₓ, A_{sy}, and A_{sz} to the vehicle control device 4. The vehicle control device 4 controls acceleration and deceleration of the vehicle 1 on the basis of the acceleration A, angular acceleration, and the like generated in the vehicle 1. The straight traveling acceleration/deceleration determination section 36 corresponds to a straight traveling acceleration and deceleration determination section.

The acquisition section 31 includes low-pass filters 32 and 33. The low-pass filter 32 allows a low-frequency component of the signal representing the acceleration Aₛₓ acquired from the acceleration sensor 20 to pass through. The low-pass filter 33 allows a low-frequency component of the signal representing the acceleration A_{sy} acquired from the acceleration sensor 20 to pass through. The low-pass filters 32 and 33 are provided to remove noise components from the signal representing the acceleration A.

The low-pass filters 32 and 33 respectively output the signal to the addition section 34 and the subtraction section 35. The addition section 34 adds the signal input from the low-pass filter 32 and the signal input from the low-pass filter 33. The subtraction section 35 subtracts the signal input from the low-pass filter 33 from the signal input from the low-pass filter 32. That is, the subtraction section 35 subtracts the acceleration A_{sy} from which the noise component is removed from the acceleration Aₛₓ from which the noise component is removed.

The straight traveling acceleration/deceleration determination section 36 determines whether the vehicle 1 is traveling straight. A calculation value calculated by the addition section 34 and a calculation value calculated by the subtraction section 35 are input to the straight traveling acceleration/deceleration determination section 36. These calculation values are calculated based on the signals output from the acceleration sensor 20. When the vehicle 1 is accelerating or decelerating in the straight traveling direction, the acceleration A in the vehicle front-rear direction is generated in the vehicle 1, and acceleration or deceleration in the vehicle width direction is not generated. Therefore, it is possible to determine whether the vehicle 1 is accelerating or decelerating in the straight traveling direction, from the signals output from the acceleration sensor 20.

In addition, a detection value of a steering sensor 2 and a yaw angular velocity detection value of the gyro sensor 3 are also input to the straight traveling acceleration/deceleration determination section 36. The detection value of the steering sensor 2 and the yaw angular velocity detection value of the gyro sensor 3 are straight traveling determination signals for determining whether the vehicle 1 is traveling straight. Note that only one of the detection value of the steering sensor 2 and the detection value of the gyro sensor 3 may be input to the straight traveling acceleration/deceleration determination section 36 as the straight traveling determination signal. Although FIG. 3 illustrate the state where the gyro sensor 3 is not included in the acceleration detection device 10, the gyro sensor 3 may be integrated with the acceleration sensor 20 included in the acceleration detection device 10.

The mounting angle calculation section 37 calculates the yaw mounting angle Δθ by using the calculation value calculated by the addition section 34, the calculation value calculated by the subtraction section 35, and an angle calculation formula described below. The mounting angle calculation section 37 outputs the calculated yaw mounting angle Δθ to the vehicle control device 4. The vehicle control device 4 corrects the accelerations Aₛₓ and A_{sy} output from the acquisition section 31 by using the yaw mounting angle Δθ and uses the corrected accelerations for vehicle control.

### Angle Calculation Formula

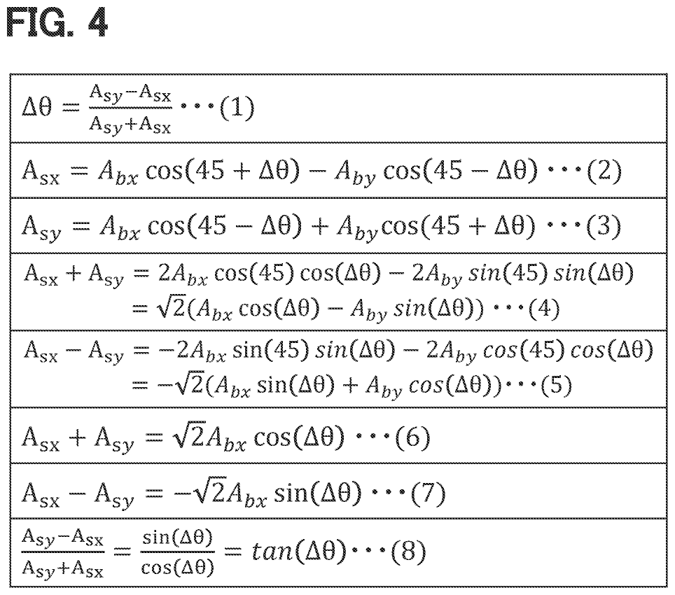

Next, the angle calculation formula will be described. In the present embodiment, Equation (1) shown in FIG. 4 is used as the angle calculation formula. A method for deriving Equation (1) will be described below. Equations (2) and (3) shown in FIG. 4 are established based on the geometric relation illustrated in FIG. 1.

The left sides of Equations (2) and (3) and the right sides of Equations (2) and (3) are each added together, and the right side of the result is deformed by using the addition theorem, whereby Equation (4) is obtained. In addition, the left side and the right side of Equation (3) are respectively subtracted from the left side and the right side of Equation (2), and the right side of the result is deformed using the addition theorem, whereby Equation (5) is obtained. The angle calculation formula shown by Equation (1) assumes a state where the acceleration A_{bx} in the front-rear direction is generated in the vehicle 1 but the acceleration A_{by} in the vehicle width direction is an acceleration A that is small enough to consider that substantially no acceleration is generated. When this assumption is applied to Equations (4) and (5), the second terms in the parentheses can be eliminated in Equations (4) and (5), and Equations (6) and (7) are obtained. By using Equations (6) and (7), the calculation shown by Equation (8) can be further performed.

In the present embodiment, the acceleration sensor 20 is mounted such that the yaw mounting angle Δθ is ±15° or less. When the yaw mounting angle Δθ is ±15° or less, tan θ can be approximated as tan θ≈θ(rad). This is because tan(15 π/180) is approximately 0.259, and 15° is 0.261 (rad). When tan θ≈θ is applied to Equation (8), Equation (1) is obtained.

### Flow of Processing

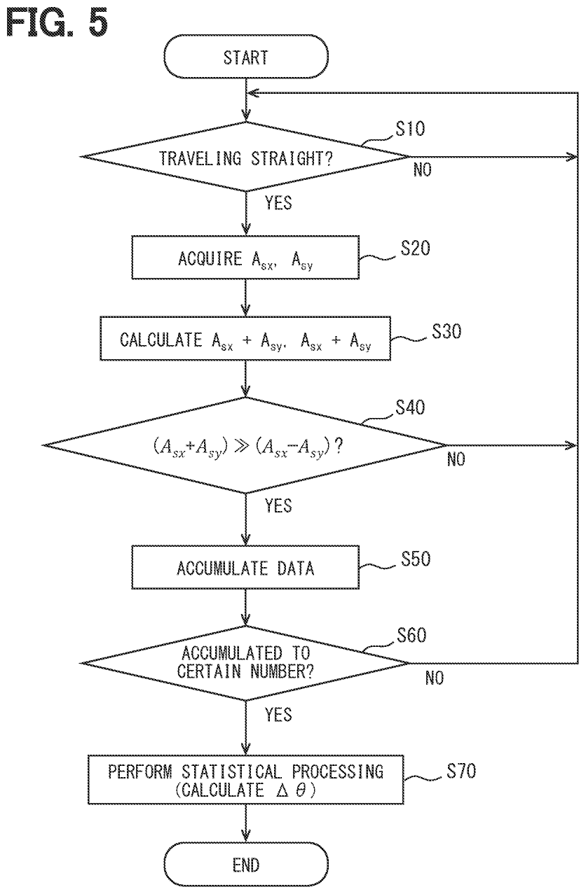

FIG. 5 illustrates a flow of processing until the yaw mounting angle Δθ is calculated. The processing illustrated in FIG. 5 can be performed at the time of traveling of the vehicle 1 in a case where the yaw mounting angle Δθ is not calculated. Alternatively, even in a case where the yaw mounting angle Δθ is calculated, the yaw mounting angle Δθ may be calculated at the time of traveling of the vehicle 1 when a certain period of time has elapsed after the yaw mounting angle Δθ was calculated.

In step S10, the straight traveling acceleration/deceleration determination section 36 determines whether the vehicle 1 is traveling straight, by using one or both of the detection values of the steering sensor 2 and the yaw angular velocity detection value of the gyro sensor 3. When the detection value of the steering sensor 2 indicates that a steering angle is around 0°, it can be determined that the vehicle 1 is traveling straight. When the yaw angular velocity detection value indicates that a yaw angular velocity is around 0, it may be determined that the vehicle 1 is traveling straight.

When a determination result of step S10 is NO, the determination in step S10 is repeated. When the determination result of step S10 is YES, the process proceeds to step S20. In step S20, the acquisition section 31 acquires the accelerations Aₛₓ and A_{sy} from the acceleration sensor 20. In step S30, the addition section 34 and the subtraction section 35 calculate Aₛₓ+A_{sy} and Aₛₓ−A_{sy} on the basis of the accelerations Aₛₓ and A_{sy} acquired in step S20.

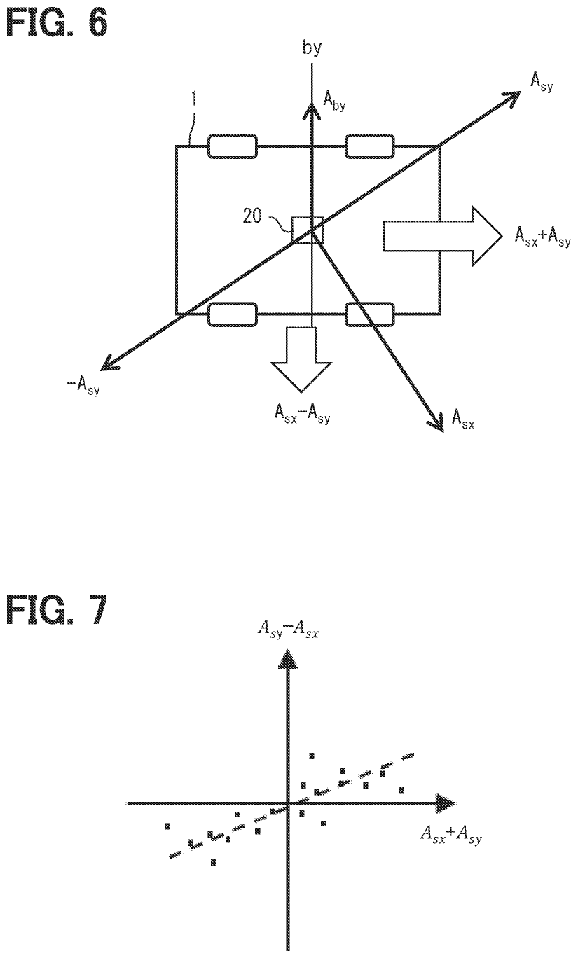

In step S40, the straight traveling acceleration/deceleration determination section 36 uses a calculation result of step S30 to determine whether Aₛₓ+A_{sy} is sufficiently larger than Aₛₓ−A_{sy}. As illustrated in FIG. 6, Aₛₓ+A_{sy} is a substitute value for the acceleration A in the vehicle front-rear direction, and Aₛₓ−A_{sy} is a substitute value for the acceleration A in the vehicle width direction. In step S40, it is determined whether the acceleration A_{bx} is generated and the acceleration A_{by} is substantially 0, that is, whether the vehicle 1 is accelerating or decelerating only in the straight traveling direction.

Since the angle calculation formula is a formula calculated on the assumption that the acceleration A_{by} is zero, it is determined whether the acceleration A_{by} is substantially zero also when acquiring the data to be substituted into the angle calculation formula. In a specific example of the determination in step S40, when Aₛₓ+A_{sy} is larger than Aₛₓ−A_{sy} by a predetermined value, the determination result of step S40 can be set to YES. Alternatively, when Aₛₓ+A_{sy} is greater than or equal to a predetermined multiple of Aₛₓ−A_{sy}, the determination result of step S40 may be YES.

Alternatively, Aₛₓ cos α+A_{sy} cos (π/2−α) may be used instead of Aₛₓ+A_{sy}, and Aₛₓ cos (π/2−α)−A_{sy} cos α may be used instead of Aₛₓ−A_{sy}. The value a is an assumed angular difference between the sx-axis and the bx-axis. When the determination result of step S40 is NO, step S10 is executed again. When the determination result of step S40 is YES, the process proceeds to step S50.

In step S50, the mounting angle calculation section 37 accumulates the calculation value calculated in step S30. In step S60, the mounting angle calculation section 37 determines whether the accumulated calculation value has reached a certain number. When the determination result of step S60 is NO, the process returns to step S10. When the determination result of step S60 is YES, the process proceeds to step S70. The certain number is a value determined in advance, and is a number for ensuring accuracy required in statistical processing in step S70.

In step S70, the data accumulated in step S50 is statistically processed to calculate the yaw mounting angle Δθ. In an example of the statistical processing, a slope of the approximate straight line is estimated. FIG. 7 illustrates an example of the approximate straight line. In FIG. 7, the horizontal axis represents Aₛₓ+A_{sy}, and the vertical axis represents Aₛₓ−A_{sy}. Therefore, the slope of the approximate straight line that linearly approximate the data shown in FIG. 7 is the yaw mounting angle Δθ. In another example of the statistical processing, a mode value of the yaw mounting angle Δθ calculated based on the accumulated data may be adopted. The yaw mounting angle Δθ obtained by the statistical processing is output to the vehicle control device 4.

The vehicle control device 4 can calculate the directions of the sx-axis and the sy-axis on the basis of the yaw mounting angle Δθ. However, the arithmetic device 30 may also calculate the directions of the sx-axis and the sy-axis and output the calculated directions to the vehicle control device 4.

In the first embodiment described above, the virtual line VL is set between the sx-axis and the sy-axis. When it is assumed that the acceleration A_{by} in the vehicle width direction is not substantially generated and that tan Δθ can be approximated to Δθ, an angle calculation formula (Equation (1)) for calculating the yaw mounting angle Δθ can be derived.

The angle calculation formula is a formula derived assuming a state where the acceleration A_{bx} is generated in the vehicle front-rear direction and the acceleration A_{by} is not generated in the vehicle width direction. When the pitch angle of the vehicle 1 is not zero, the acceleration A caused by the inclination in the front-rear direction of the vehicle 1 is applied along the sx-axis and the sy-axis. However, the angle calculation formula is a formula assuming that the acceleration A_{bx} in the vehicle front-rear direction is generated. Therefore, even when the sx-axis and the sy-axis of the acceleration sensor 20 are inclined in the vehicle front-rear direction with respect to the horizontal plane, a decrease in a calculation accuracy of the yaw mounting angle Δθ is prevented or reduced.

The virtual line VL bisects between the sx-axis and the sy-axis. When the acceleration sensor 20 is mounted such that the yaw mounting angle Δθ between the virtual line VL and the bx-axis is ±15° or less, the angle between each of the sx-axis and the sy-axis and the bx-axis is close to 45°. As a result, it is possible to prevent or reduce the chance that one of Aₛₓ and A_{sy} to be substituted into Equation (1) becomes extremely small, the yaw mounting angle Δθ can be calculated more accurately.

The acceleration detection device 10 includes the straight traveling acceleration/deceleration determination section 36. The straight traveling acceleration/deceleration determination section 36 determines whether the vehicle 1 is accelerating or decelerating in the straight traveling direction on the basis of the output signals of the acceleration sensor 20 (step S40). The accelerations Aₛₓ and A_{sy} when the determination result of step S40 is NO are not used as the data for calculating the yaw mounting angle Δθ. Also by this processing, the yaw mounting angle Δθ can be accurately calculated.

Further, the straight traveling acceleration/deceleration determination section 36 does not just determine whether the vehicle 1 is accelerating or decelerating in the straight traveling direction by using the output signals of the acceleration sensor 20. The straight traveling acceleration/deceleration determination section 36 determines whether the vehicle 1 is traveling straight, also in step S10. In step S10, by using one or both of the detection values of the steering sensor 2 and the yaw angular velocity detection value of the gyro sensor 3, the straight traveling acceleration/deceleration determination section 36 determines whether the vehicle 1 is traveling straight.

In a case where it is determined whether the vehicle 1 is traveling straight by using the output signals of the acceleration sensor 20, there is a possibility that a state where the vehicle 1 is traveling in a curve on an inclined road surface is erroneously determined as a state of traveling straight. In detail, this is due to the following reason. Even in a case where the acceleration A in the by direction is generated due to the curve traveling of the vehicle 1, because the road surface is inclined, the gravitational acceleration generated in the vehicle 1 may be in such a direction that the gravitational acceleration generated in vehicle 1 offsets the acceleration A generated by the curve traveling.

However, in the present embodiment, whether the vehicle 1 is traveling straight is determined using one or both of the detection values of the steering sensor 2 and the yaw angular velocity detection value of the gyro sensor 3. Therefore, it is possible to prevent or reduce the chance that the yaw mounting angle Δθ is calculated based on the acceleration A detected by the acceleration sensor 20 in a state where the vehicle 1 is traveling on a curve.

### Second Embodiment

Next, a second embodiment will be described. In the description of the second embodiment and subsequent embodiments, elements having the same reference signs as the already used reference signs are the same elements as the elements shown in the previous embodiments and having the same reference signs unless otherwise specified. In the case where only a part of the configuration is described, previously described other embodiments can be applied to the other part of the configuration.

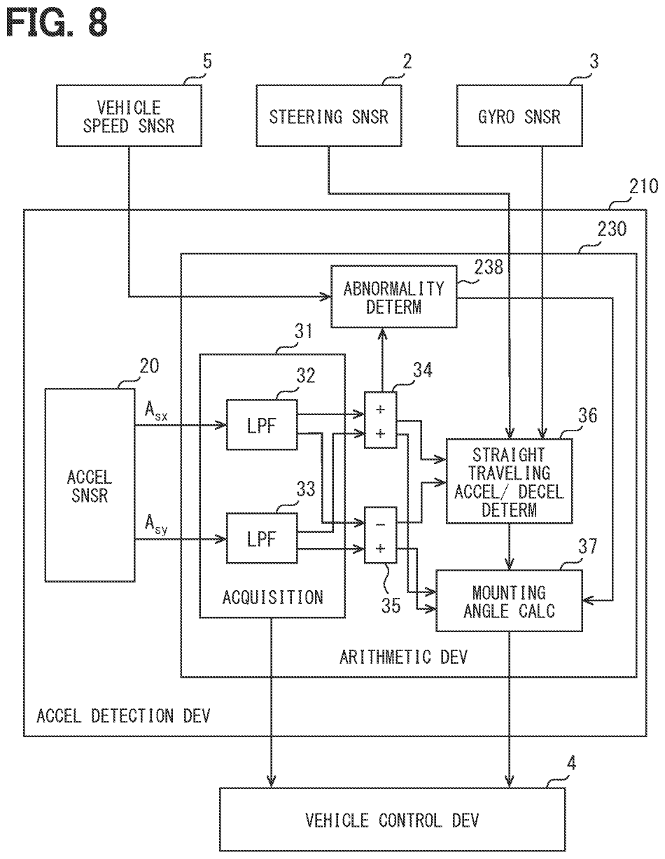

FIG. 8 illustrates a configuration of an acceleration detection device 210 of the second embodiment. The acceleration detection device 210 includes an abnormality determination section 238. The abnormality determination section 238 determines whether the acceleration sensor 20 is abnormal. The abnormality determination section 238 acquires a signal representing the vehicle speed of the vehicle 1 from a vehicle speed sensor 5 in order to determine whether the acceleration sensor 20 is abnormal. In addition, the abnormality determination section 238 acquires a calculation value calculated by the addition section 34. These two are compared to determine whether the acceleration sensor 20 is abnormal.

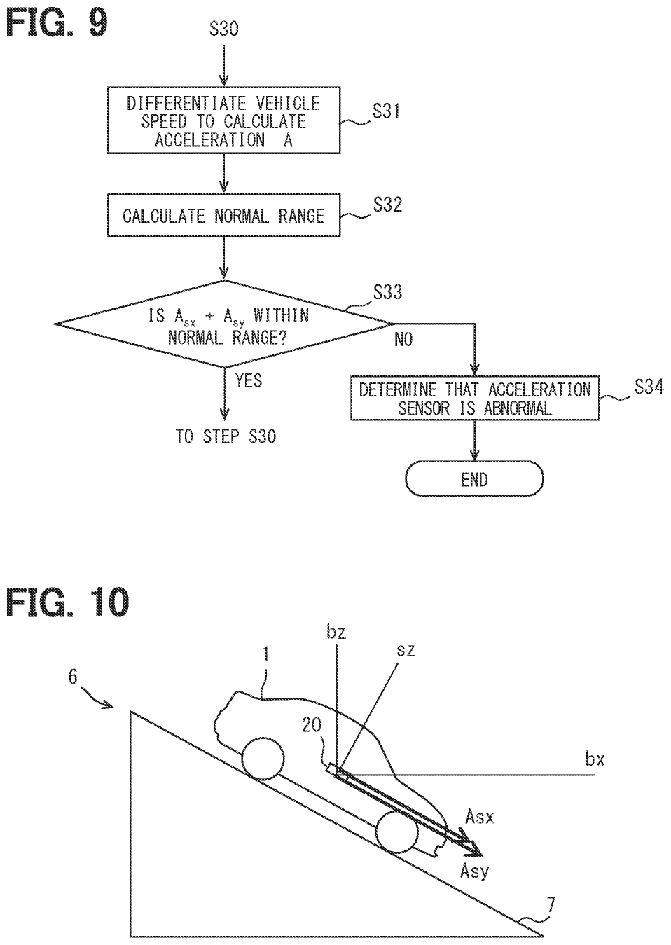

FIG. 9 illustrates processing performed by the abnormality determination section 238. Step S31 is executed subsequent to step S30. In step S31, the acceleration A in the vehicle front-rear direction is calculated by differentiating the vehicle speed determined by the signal acquired from the vehicle speed sensor 5.

In step S32, a normal range determined based on the acceleration A calculated in step S31 is calculated. The normal range is a range for determining whether Aₛₓ+A_{sy} is normal. Aₛₓ+A_{sy} represents the acceleration A in the front direction of the vehicle 1 as illustrated in FIG. 7. The acceleration A calculated in step S31 is also the acceleration A in the vehicle front direction. Therefore, the normal range for determining whether Aₛₓ+A_{sy} is normal can be calculated based on the acceleration A calculated in step S31. A formula for calculating the normal range from the acceleration A calculated in step S31 is determined in advance.

In step S33, it is determined whether Aₛₓ+A_{sy} calculated in step S30 is included within the normal range calculated in step S32. This is equivalent to comparison between the acceleration A calculated in step S31 and Aₛₓ+A_{sy}. When the determination result of step S33 is NO, the process proceeds to step S34. In step S34, it is determined that the acceleration sensor 20 is abnormal. Then, the processing is terminated without calculating the yaw mounting angle Δθ.

In this manner, the abnormality determination section 238 compares the acceleration A obtained by differentiating the vehicle speed with Aₛₓ+A_{sy} representing the acceleration A in the front direction of the vehicle 1 calculated from the output signals of the acceleration sensor 20 (step S33). When the acceleration sensor 20 is determined to be abnormal by this comparison, the mounting angle calculation section 37 does not calculate the yaw mounting angle Δθ. As a result, it is possible to prevent or reduce the chance that the yaw mounting angle Δθ having an abnormal value is calculated.

### Third Embodiment

In a third embodiment, the vehicle 1 is placed on an inspection table 6 illustrated in FIG. 10, and the yaw mounting angle Δθ is calculated when the vehicle 1 is stopped. The inspection table 6 is installed, for example, in a manufacturing factory of the vehicle 1. The inspection table 6 has an upper face 7 on which the vehicle 1 is to be placed, and upper face 7 is flat and inclined.

With reference to FIG. 10, the vehicle 1 is inclined forward in the front-rear direction and is not inclined in the left-right direction. In this state, as illustrated also in FIG. 10, the acceleration sensor 20 detects, due to gravity, the acceleration A in the sx-axis direction and the sy-axis direction. Since the acceleration sensor 20 detects the acceleration A in the sx-axis direction and the sy-axis direction, the yaw mounting angle Δθ can be calculated from Equation (1) even when the vehicle 1 is not traveling. The inclination of the upper face 7 of the inspection table 6 is determined such that the magnitudes of the accelerations Aₛₓ and A_{sy} are large enough to accurately calculate the yaw mounting angle Δθ.

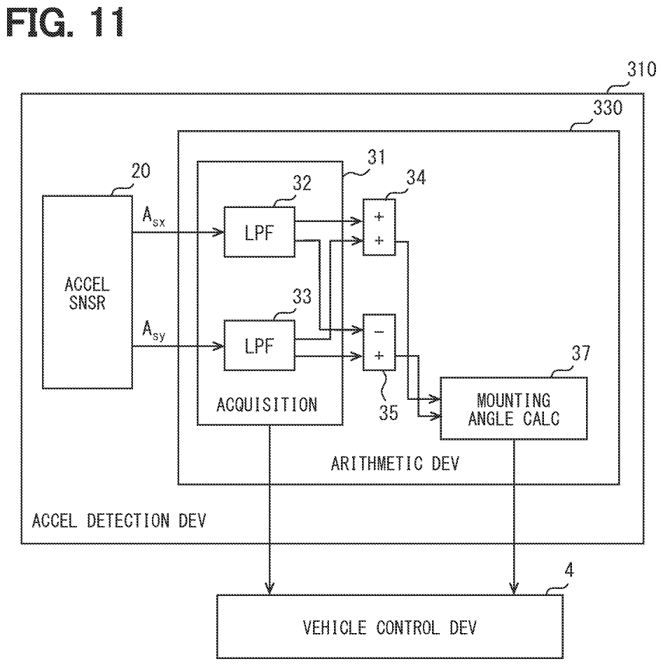

FIG. 11 illustrates a configuration of an acceleration detection device 310 of the third embodiment. Since the yaw mounting angle Δθ is calculated with the vehicle 1 placed on the inspection table 6, the acceleration detection device 310 does not include the straight traveling acceleration/deceleration determination section 36 unlike the acceleration detection device 10 of the first embodiment. The mounting angle detection method performed using the acceleration detection device 310 of the third embodiment is a method in which step S10 and step S40 in FIG. 5 are removed.

Since, in the mounting angle detection method described in the third embodiment, it is not necessary to cause the vehicle 1 to travel, the yaw mounting angle Δθ can be easily detected before the vehicle 1 is shipped.

### Fourth Embodiment

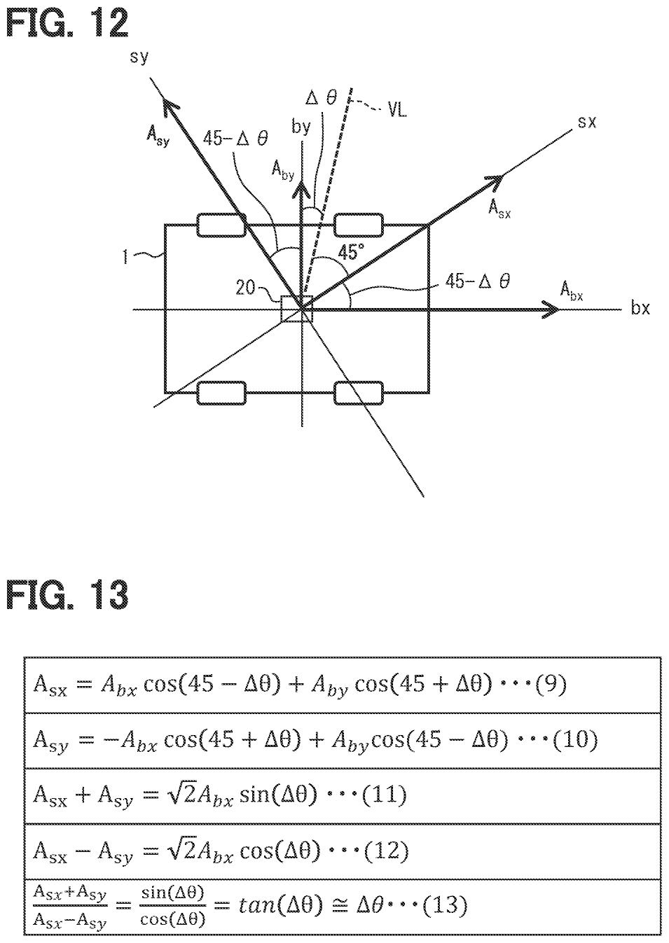

In a fourth embodiment, the directions of the sx-axis and the sy-axis of an acceleration sensor 20 are different from those in the previous embodiments. As illustrated in FIG. 12, in the fourth embodiment, the acceleration sensor 20 is rotated counterclockwise by 90° about the sz-axis with respect to the direction of the first embodiment. The yaw mounting angle Δθ is an angle between the virtual line VL and the by-axis. In the fourth embodiment, the by-axis is the vehicle reference axis. The acceleration sensor 20 is mounted on the vehicle 1 such that an angle θ between the virtual line VL and the by-axis is ±15° or less.

In the fourth embodiment, Equations (9) and (10) shown in FIG. 13 are established based on the geometric relation illustrated in FIG. 12. The left sides of Equations (9) and (10) and the right sides of Equations (9) and (10) are each added together, and the right side of the result is deformed by using the addition theorem, and A_{by}=0 is substituted, whereby Equation (11) is obtained. In addition, the left side and the right side of Equation (10) are respectively subtracted from the left side and the right side of Equation (9), and the right side of the result is deformed using the addition theorem, and A_{by}=0 is substituted, whereby Equation (12) is obtained. Furthermore, Equation (13), which is the angle calculation formula, is obtained from Equations (11) and (12).

As described above, also when the acceleration sensor 20 is oriented as described in the fourth embodiment, the angle calculation formula for calculating the yaw mounting angle Δθ can be derived from Aₛₓ and A_{sy}.

### Fifth Embodiment

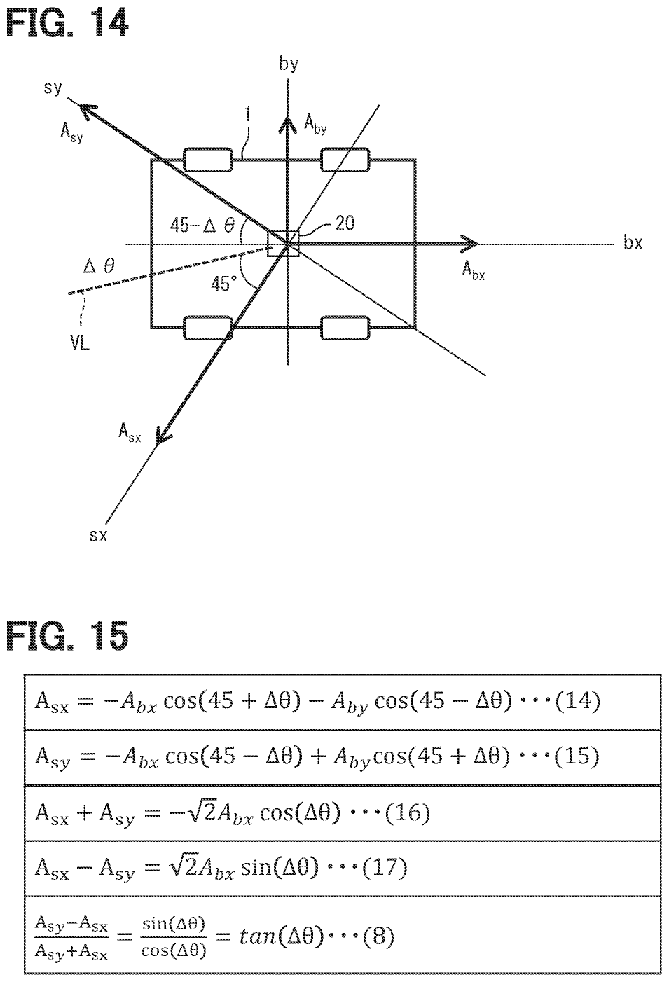

In a fifth embodiment, as illustrated in FIG. 14, the acceleration sensor 20 is rotated by 180° about the sz-axis with respect to the direction of the first embodiment. The yaw mounting angle Δθ is an angle between the virtual line VL and the bx-axis similarly to the first embodiment.

In the fifth embodiment, Equations (14) and (15) shown in FIG. 15 are established based on the geometric relation illustrated in FIG. 14. The left sides of Equations (14) and (15) and the right sides of Equations (14) and (15) are each added together, and the right side of the result is deformed by using the addition theorem, and A_{by}=0 is substituted, whereby Equation (16) is obtained. In addition, the left side and the right side of Equation (15) are respectively subtracted from the left side and the right side of Equation (14), and the right side of the result is deformed using the addition theorem, and A_{by}=0 is substituted, whereby Equation (17) is obtained. Furthermore, Equation (8), which is the same equation as that in the first embodiment, is obtained from Equations (16) and (17). Therefore, also in the fifth embodiment, the yaw mounting angle Δθ can be calculated using Equation (1) that is the same equation as that in the first embodiment, as the angle calculation formula.

### Sixth Embodiment

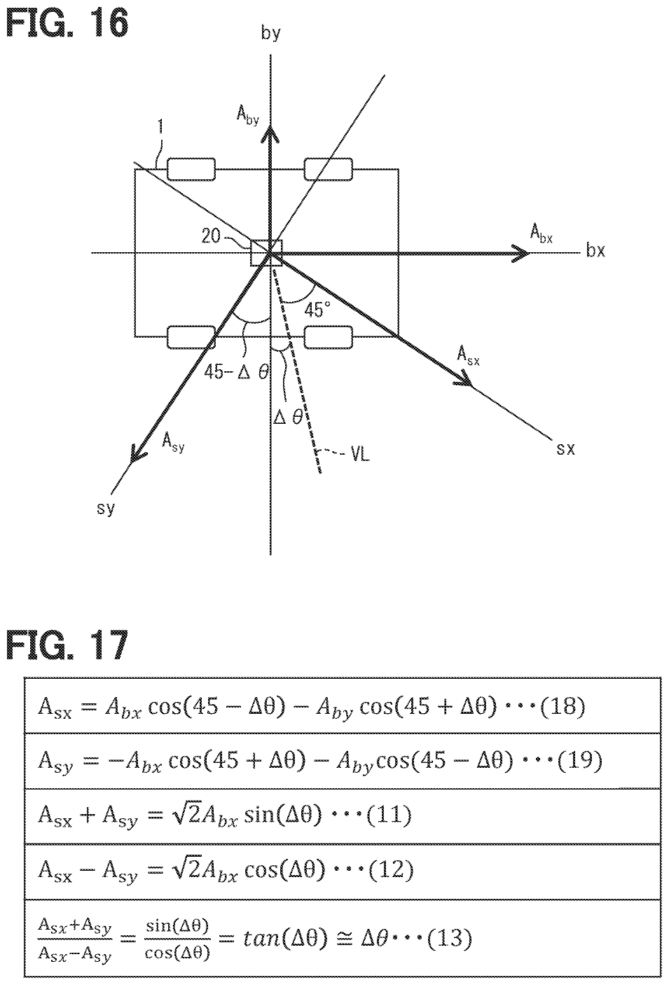

In a sixth embodiment, as illustrated in FIG. 16, the acceleration sensor 20 is rotated counterclockwise by 270° about the sz-axis with respect to the direction of the first embodiment. It can also be said that the acceleration sensor 20 is rotated by 180° about the sz-axis with respect to the fourth embodiment. The yaw mounting angle Δθ is an angle between the virtual line VL and the by-axis similarly to the fourth embodiment.

In the sixth embodiment, Equations (18) and (19) shown in FIG. 17 are established based on the geometric relation illustrated in FIG. 16. The left sides of Equations (18) and (19) and the right sides of Equations (18) and (19) are each added together, and the right side of the result is deformed by using the addition theorem, and A_{by}=0 is substituted, whereby Equation (11) shown in the fourth embodiment is obtained. In addition, the left side and the right side of Equation (19) are respectively subtracted from the left side and the right side of Equation (18), and the right side of the result is deformed using the addition theorem, and A_{by}=0 is substituted, whereby Equation (12) shown in the fourth embodiment is obtained. Therefore, in the sixth embodiment, the yaw mounting angle Δθ can be calculated using Equation (13) in the same manner as in the fourth embodiment.

### Seventh Embodiment

In the above embodiments, the virtual line VL is a line bisecting between the sx-axis and the sy-axis. However, the virtual line VL can be arbitrarily set between the sx-axis and the sy-axis. Assuming that the angle between the virtual line VL and the sx-axis is a and the angle between the virtual line VL and the sy-axis is β.

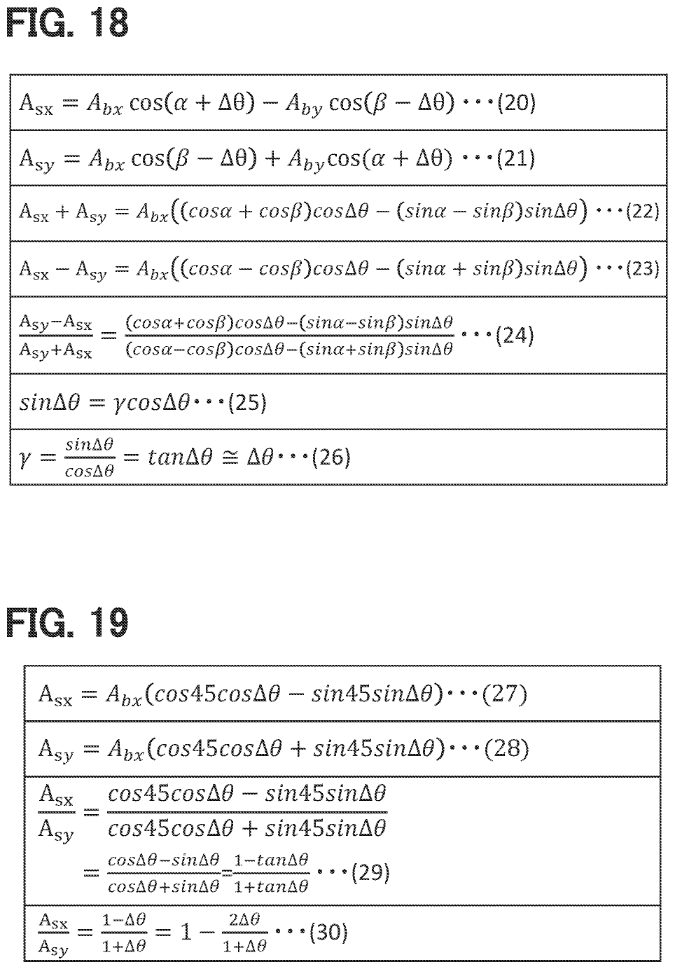

When Equations (2) and (3) are generalized using a and 13, Equations (20) and (21) shown in FIG. 18 are obtained. Addition is performed on each of the right side of Equations (20) and (21) and the left sides of Equations (20) and (21), subtraction is performed on each of the right side of Equations (20) and (21) and the left sides of Equations (20) and (21), and A_{by}=0 is substituted, whereby Equations (22) and (23) are obtained. Furthermore, Equation (24) is obtained from Equations (22) and (23). In Equation (24), numerical values are obtained except sin Δθ and cos Δθ. When the numerical values are calculated, Equation (25) is obtained. In Formula (25), y is a numerical value. Equation (26) is further obtained from Equation (25). Since Equation (26) can be obtained, it is understood that the virtual line VL can be arbitrarily set between the sx-axis and the sy-axis.

### Eighth Embodiment

In an eighth embodiment, the angle calculation formula different from that described above is shown. When A_{by}=0 is substituted into Equations (2) and (3), and the right sides are deformed by the addition theorem, Equations (27) and (28) shown in FIG. 19 are obtained. Since the equation cos 45=sin 45 is established, Equation (28) can be further deformed into Equation (29). By using the approximation of tan Δθ≈Δθ, Equations (30) can be obtained from Equation (29). The yaw mounting angle Δθ may be calculated using Equation (30) as the angle calculation formula.

Although the embodiments have been described above, the disclosed techniques are not limited to the above-described embodiments, and the following modifications are also included in the disclosed scope, and various modifications other than the followings can be made without departing from the gist.

### First Modification

As for the acceleration sensor 20, it is possible to separately include a sensor that detects the acceleration A in the sx-axis direction and a sensor that detects the acceleration A in the sy-axis direction. The acceleration sensor 20 may be a sensor including only an sx-axis and an sy-axis, instead of including three axes.

### Second Modification

Band-pass filters may be used instead of the low-pass filters 32 and 33. When the band-pass filters are used, it is easy to remove biases.

### Third Modification

In the first embodiment, it is determined in step S10 whether the vehicle is traveling straight, and it is determined in step S40 whether the vehicle is accelerating or decelerating only in the straight traveling direction. However, only either one of the determinations may be made.

What is claimed is:

1. An acceleration detection device mounted on a vehicle, the acceleration detection device comprising:
an acceleration sensor that has at least a first detection axis and a second detection axis orthogonal to each other and is mounted on the vehicle such that a yaw mounting angle between a vehicle reference axis that is either a vehicle front-rear direction axis or a vehicle width direction axis and a virtual line set between the first detection axis and the second detection axis is ±15 degrees or less;
an acquisition section that is configured to acquire, from the acceleration sensor, an acceleration in a direction of the first detection axis and an acceleration in a direction of the second detection axis in a state where acceleration in the vehicle front-rear direction is generated in the vehicle and no acceleration is generated in the vehicle width direction; and
a mounting angle calculation section that is configured to calculate the yaw mounting angle from
an angle calculation formula that calculates the yaw mounting angle from an acceleration in the direction of the first detection axis and an acceleration in the direction of the second detection axis and
the acceleration in the direction of the first detection axis and the acceleration in the direction of the second detection axis detected by the acquisition section, the angle calculation formula being derived by assuming a state where acceleration in the vehicle front-rear direction is generated in the vehicle and no acceleration is generated in the vehicle width direction and by using a fact that a tan value of the yaw mounting angle is approximated to the yaw mounting angle.

2. The acceleration detection device according to claim 1, wherein
the virtual line bisects between the first detection axis and the second detection axis.

3. The acceleration detection device according to claim 1, further comprising
a straight traveling acceleration and deceleration determination section that determines whether the vehicle is accelerating or decelerating in a straight traveling direction, based on an output signal of the acceleration sensor,
wherein
the mounting angle calculation section calculates the yaw mounting angle, based on a fact that the straight traveling acceleration and deceleration determination section determines that the vehicle is accelerating or decelerating in a straight traveling direction.

4. The acceleration detection device according to claim 3, wherein
the straight traveling acceleration and deceleration determination section determines whether the vehicle is traveling straight based on a straight traveling determination signal that is different from the output signal of the acceleration sensor.

5. The acceleration detection device according to claim 1, further comprising
an abnormality determination section that determines whether the acceleration sensor is abnormal by comparing an acceleration obtained by differentiating a vehicle speed detected by a vehicle speed sensor provided on the vehicle with an acceleration in a front direction of the vehicle determined based on an output signal of the acceleration sensor,
wherein
the mounting angle calculation section does not calculate the yaw mounting angle when the abnormality determination section determines that the acceleration sensor is in abnormal.

6. A mounting angle detection method for detecting a mounting angle of an acceleration sensor that has at least a first detection axis and a second detection axis orthogonal to each other and is disposed on a vehicle such that a yaw mounting angle between a vehicle reference axis that is either a vehicle front-rear direction axis or a vehicle width direction axis and a virtual line set between the first detection axis and the second detection axis is ±15 degrees or less, the method comprising:
acquiring, from the acceleration sensor, an acceleration in a direction of the first detection axis and an acceleration in a direction of the second detection axis in a state where acceleration in the vehicle front-rear direction is generated in the vehicle and substantially no acceleration is generated in the vehicle width direction; and
calculating the yaw mounting angle from
an angle calculation formula that calculates the yaw mounting angle from an acceleration in the direction of the first detection axis and an acceleration in the direction of the second detection axis and
the acceleration in the direction of the first detection axis and the acceleration in the direction of the second detection axis acquired, the angle calculation formula being derived by assuming a state where acceleration in the vehicle front-rear direction is generated in the vehicle and no acceleration is generated in the vehicle width direction and by using a fact that a tan value of the yaw mounting angle is approximated to the yaw mounting angle.

7. The mounting angle detection method according to claim 6, wherein
the acceleration in the direction of the first detection axis and the acceleration in the direction of the second detection axis are acquired from the acceleration sensor in a state where the vehicle is stopped on a slope that is inclined in a front-rear direction and is not inclined in a left-right direction.
